(19) United States
(12) Patent Application Publication
(10) Pub. No.: US 2021/0393061 A1
(43) Pub. Date: Dec. 23, 2021

(54) Inverted fit hanger

(71) Applicant: moshe ratzabi, Brooklyn, NY (US)

(72) Inventor: moshe ratzabi, Brooklyn, NY (US)

(21) Appl. No.: 16/908,939

(22) Filed: Jun. 23, 2020

(51) Int. Cl. A47G 25/32; F16B 45/06

(52) U.S. Cl. CPC A47G 25/32; F16B 45/06

(57) ABSTRACT

Hanger designed with a built in apparatus which allows it to be placed on a rod from bottom side of rod. Enabling this feature is an apparatus built in the top section of hanger frame. Apparatus built with two rotating semi-circulars, forming a circle when closed, appears like a disc. When hanger is pushed upward against rod, semi-circulars will open and reclose on rod, keeping hanger suspended, allowing it to glide. The instant apparatus will allow hanger to be suspended very close to rod, and will eliminate the old fashion open end hook of prior art.

### BACKGROUND OF THE INVENTION

A hanger is a very frequently used item, while very easy and convenient to use, the object of this invention is to advance its features. By using a disc like apparatus which allows the hanger to be fitted from lower side of rod and stay suspended very close to rod, maximizing space utilization. Prevents the drop down with a common hanger when first raised over rod and then dropped down to contact rod. This type of circular apparatus eliminates the old fashion open hook with a pointy tip of prior art, which at times can be less safe or may get tangled to other garment.

### SUMMARY OF THE INVENTION

This instant invention will allow the hanger to be suspended over the rod by pushing it upward against the rod, allowing it to be suspended very close to the rod. By pushing the hanger upward against the rod, the apparatus two semi-circulars will open up against a force of two springs, when fully fitted on rod, the two semi-circulars will close to keep the hanger suspended, while allowing it to glide. In purpose of removing the hanger it will have to be pulled out which will cause the inner semi-circle to rotate back and open enough gap to allow removal of the hanger by pulling it out further obliquely. This type of design will eliminate the typical open end hook design and will create a safer more rounded and symmetric profile, also creating a modern look

### DESCRIPTION OF THE DRAWINGS

FIG. 1A illustrates the two semi-circular assembled one on top of the other (semi-circulars assembly), semi-circular R and L, and their relative position when closed. S1 and S2 are the attachment points of two tension springs, which will be attached to the corresponding mounting points S1 and S2 on the housing (FIG. 2). Top section of semi-circulars—FIG. 2 (marked double edge), illustrates the section that each semi-circular has a thicker edge to form a contact surface when semi-circulars are closed against each other. FIG. 1B is a top view of semi-circulars.

FIG. 2 illustrates the semi-circulars assembled into its housing.

FIG. 3 illustrates the housing design with the relative position of spring 1 (S1) and spring 2 (S2) attachment and relative position of cam (CAM C) and cam (CAM V), (cam V and S2 reference marks referring to housing back wall).

FIG. 4A (top view) illustrates how CAM V and CAM C are situated and attached to housing inner walls. The assembly bolt (3), spring washer (4) and washer (5), secure the two semi-circulars in the housing, allowing each semi-circular to rotate away from each other, or to close toward each other to a vertical position.

FIG. 4B (side view) illustrates again CAM (C) and CAM (V) position and springs S1 and S2 attachment pins.

FIG. 5 illustrates a second design of semi-circulars (design B). Designed to allow a limited rotation of semi-circulars toward each other, allowing a gap in top end when semi-circulars are closed. A cam (7) attached to semi-circular R2 (FIG. 6A), fit into cavity (8) on semi-circular L2, which allows semi-circulars to close to a point of keeping a limited gap. Tension spring (6) keeps semi-circulars closed.

FIG. 6B is a top view of semi-circulars.

FIG. 7 illustrates the hanger with apparatus installed with the rotating semi-circulars above the hanger frame.

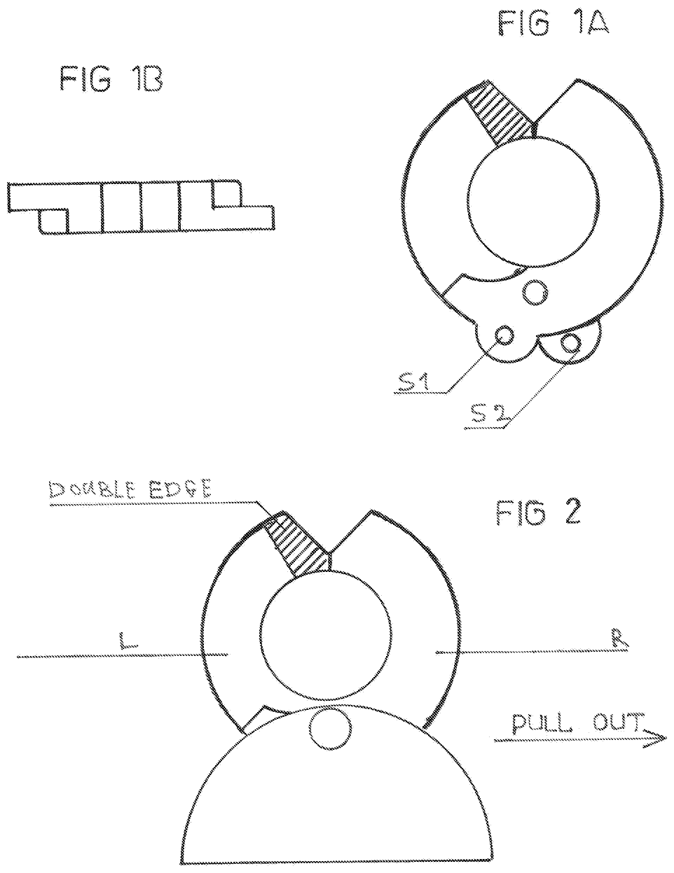

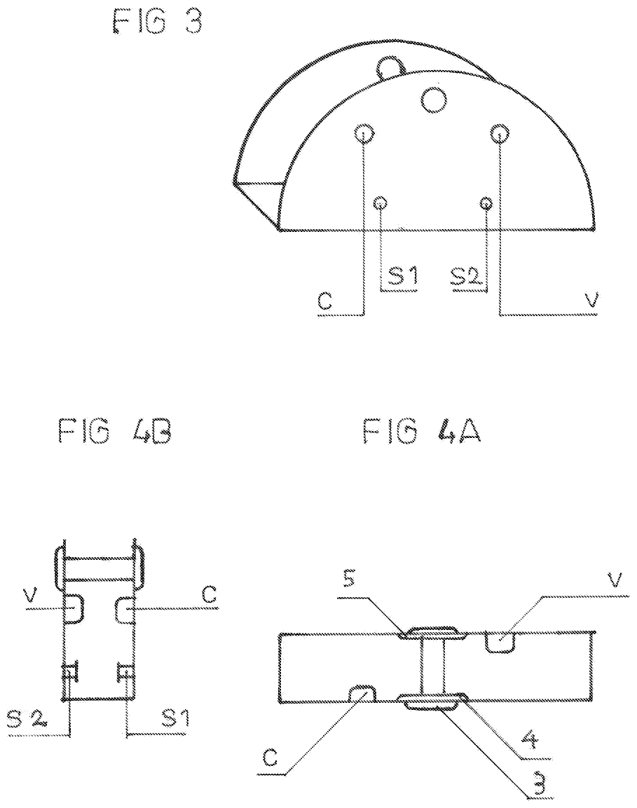

### DETAILED DESCRIPTION OF THE INVENTION

Description with design A: Apparatus assembly with its housing installed inside the top section of the hanger frame cavity, which design to match the housing counter line. Top center of hanger frame is slotted to allow the rotating semi-circulars to go through it. Detailing the way of functioning: the hanger will have to first be aligned with semi-circulars opening centered against the rod, than pushing the hanger upward against the rod, which will cause the two semi-circulars to open against a force of two springs, when fully up the semi-circulars will close and keep hanger suspended, allowing it to glide. When semi-circulars are fully closed designed to form a circle slightly larger than rod diameter. Hanger will stay suspended also on a smaller diameter rod. In purpose of removing the hanger properly it will require a specific path of motion, the hanger will have to be pulled out horizontally and further out obliquely. When first pulled out horizontally (FIG. 2, arrow), will force semi-circular L against the rod causing it to rotate counter clock wise (to the left) against a force of a tension spring S2 and opening a gap allowing hanger to be released by pulling it further obliquely. When that path of motion occur, semi-circular R will stay in its vertical position, restricted by cam C, which prevents it from rotating toward semicircular L, it will be free to rotate only away from semi-circular L, if the hanger would be placed on rod in the reversed direction, the same process will occur with opposite semi-circular, in purpose of removing the hanger it will have to be pulled out horizontally which will force semi-circular R against the rod and will cause it rotate counter clock wise (to the left) and open against a force of a tension spring S1, opening a gap allowing hanger to be released by pulling it further obliquely. In that process, semi-circular L will stay in its vertical position, restricted by cam V, which prevents it from rotating toward semi-circular R, it will be free to rotate only away from semi-circular R.

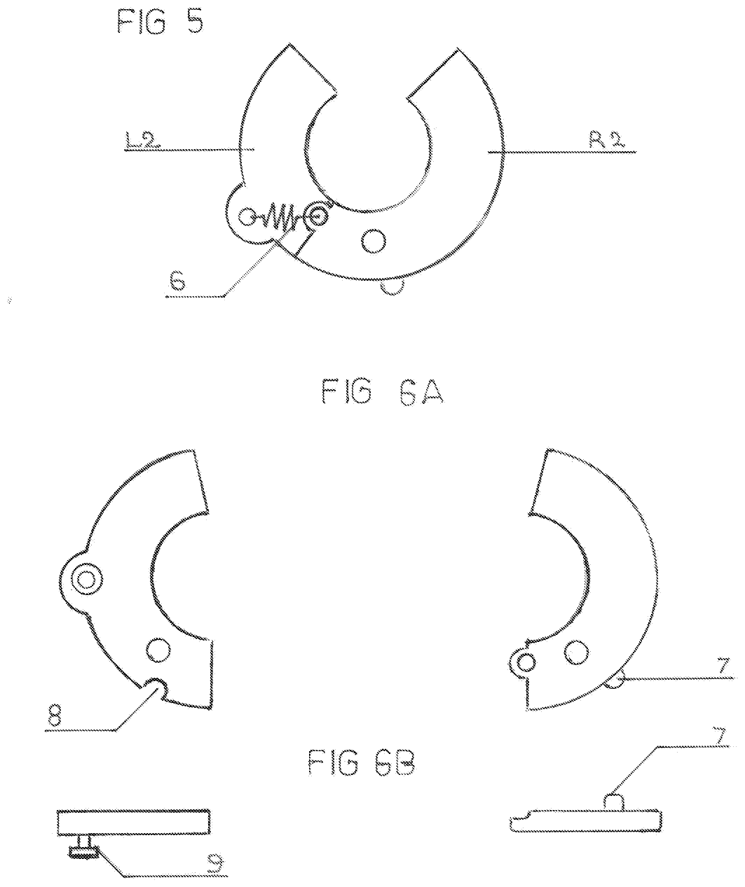

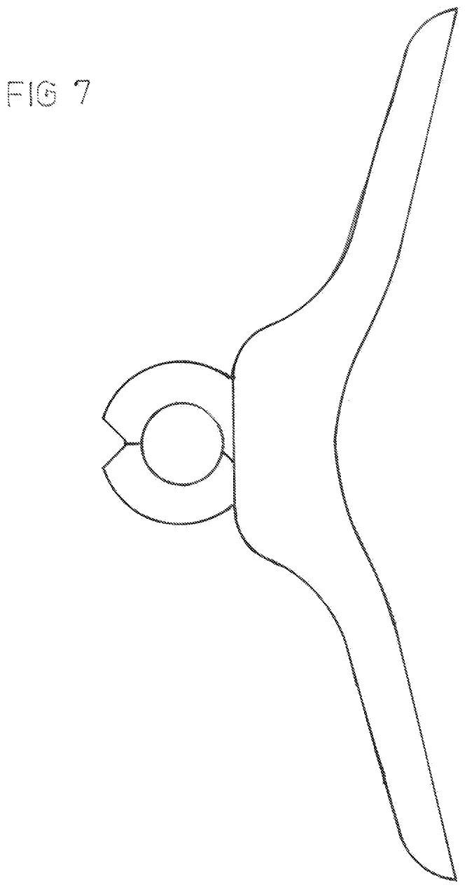

Description with design B: apparatus assembly has similarity with design A, with some variations, in this instant design (FIG. 5) a gap is left between the two semi-circulars when fully closed. A tension spring (6) attached to both semi-circulars keeps them closed. Spring (6) attached to pin (9) (FIG. 6B). FIG. 6B is a top view of semi-circulars. The housing is identical in both designs. When semi-circulars closing toward each other, closing will stop when cam (7) attached to semi-circular R2 (FIG. 6A) will contact cavity (8) on semi-circular L2, to conform a circle of about 310 degrees, leaving a gag on top end of semi-circulars.

Detailing the way of functioning: the hanger will have to first be aligned with semi-circulars gap centered against the rod, than pushed upward which will cause semi-circulars to open, when fully up semi-circulars will close, keeping hanger suspended allowing it to glide. In purpose of removing the hanger it will have to be pulled out horizontally (FIG. 5) which will force semi-circular L2 against the rod causing it to rotate (counter clockwise) away from semi-circular R2, opening a gap wide enough to allow the release of hanger by pulling it out further obliquely. In this process semi-circular R2 is restricted by cam C from following rotation of semi-circular L2. If the hanger was suspended on rod in reversed direction the same process will occur with opposite semi-circular. In purpose of removing the hanger than, it will have to be pulled out horizontally, which will force semi-circular R2 against the rod causing it to rotate away from semi-circular L2 opening a gap wide enough to allow the release of hanger by pulling out further obliquely. In this process semi-circular L2 is restricted by cam V from following rotation of semi-circular R2. This instant design will fit the largest diameter rod designed for, slightly smaller than the diameter conformed by semi-circulars, or a smaller diameter rod size larger than semi-circulars gap. This instant design demonstrates the enabling of suspending of hanger without contact with top surface of rod.

1: Invention apparatus will enable hanger to be suspended very close to rod which will allow it to maximize space utilization, especially in confined spaces with height limitation and more significant on a two level setting.

2: Apparatus will enable mounting of rod very close to a cabinetry ceiling, since hanger is placed from bottom side of rod.

3: Apparatus designed with two semi-circulars, forming a disc shape, eliminating the pointy open end hook of prior art which can get tangled to other garment, and at times can be less safe, which make this apparatus safer.

4: This instant apparatus, conform a rounded and shallower symmetrical top over hanger frame, creating a modern safer design.

5: This instant apparatus will prevent hanger from falling by unintended push on hanger or by pulling other hanger when stocked tightly.

6: Apparatus design will allow easier marking to identify one item or a group of items since marking flat surface of apparatus semi-circulars will be visible.

7: Apparatus design will allow to create a color coding since semi-circulars, disc shape have a suitable surface to make color visible. Apparatus suspended closely to rod will make it more visible.

8: Apparatus with design B will enable hanger to be suspended without contact with top surface of rod.
